(19) United States
(12) Patent Application Publication
(10) Pub. No.: US 2024/0289118 A1
(43) Pub. Date: Aug. 29, 2024

(54) IMAGE PROCESSING DEVICE, SYSTEM INCLUDING DEVICE MANAGEMENT SYSTEM AND IMAGE PROCESSING DEVICE, AND METHOD FOR CONTROLLING IMAGE PROCESSING DEVICE

(71) Applicant: Canon Kabushiki Kaisha, Tokyo (JP)

(72) Inventor: TOSHIAKI IGARASHI, Kanagawa (JP)

(21) Appl. No.: 18/582,729

(22) Filed: Feb. 21, 2024

(30) Foreign Application Priority Data
Feb. 27, 2023 (JP) 2023-028837

(51) Int. Cl. G06F 8/65; H04N 1/00

(52) U.S. Cl. CPC G06F 8/65; H04N 1/00962

(57) ABSTRACT

An image processing device acquires and manages a code for restoring a connection relationship with a device management system for providing a service from the device management system when information of the image processing device has already been registered in the device management system so as to be provided with a service, and restores the connection relationship with the device management system using the code when updating of software of the image processing device, which is required to restore the connection relationship for providing a service with the device management system, has occurred.

### BACKGROUND OF THE INVENTION

### Field of the Invention

The present invention relates to a device management system for continuously managing an image processing device.

### Description of the Related Art

In recent years, device management systems utilizing a cloud service (which hereinafter will be referred to as a CS) provided on the Internet to manage devices represented by multifunction peripherals have been proposed. In such management systems, first, a manager of a CS tenant (units of user group) registers devices. Subsequently, the manager performs device management, job management, and the like including updating of firmware (which hereinafter will be referred to as FW) with respect to the devices which have already been registered. Japanese Patent Laid-Open No. 2017-167857 discloses a form in a CS and a device connected thereto in which the CS transmits FW for updating to the device and the device updates the FW when a user instructs updating of the FW of the device from the CS. Here, a connection state between the CS and the device is still maintained even after the FW is updated. In this manner, in the case of version-up of FW, it is common for updated FW to perform migration to maintain compatibility with the FW before updating.

However, in the case of version-down, since updated FW may not be able to understand data of the original structure, there is a probability of a startup failure. In order to prevent a startup failure, a mechanism for initializing various kinds of settings at the time of version-down of FW is generally incorporated into devices. For this reason, in the system disclosed in Japanese Patent Laid-Open No. 2017-167857, there is concern that connection between a device and a CS may be cancelled during FW updating accompanying version-down of the FW. If connection between a device and a CS is cancelled, a manager who manages many devices has to visit the installation place of each device and check whether processing of updating FW of the device has succeeded. Moreover, thereafter, the manager has to manually restore the connection between the device and the CS, resulting in a heavy burden on the manager.

### SUMMARY OF THE INVENTION

The present invention restores connection between a device and a cloud service undone when software of the device is updated.

An image processing device of the present invention has an acquiring means for acquiring a code for restoring a connection relationship with a device management system for providing a service from the device management system when information of the image processing device has already been registered in the device management system so as to be provided with a service, a managing means for managing the code, and a restoring means for restoring the connection relationship with the device management system using the code when updating of software of the image processing device, which is required to restore the connection relationship for providing a service with the device management system, has occurred.

Further features of the present invention will become apparent from the following description of exemplary embodiments with reference to the attached drawings.

### BRIEF DESCRIPTION OF THE DRAWINGS

FIG. 1 is a view showing a constitution of a system.

FIGS. 2A and 2B are views showing an information processing device and a hardware constitution of a device.

FIGS. 3A and 3B are views showing software constitutions of a device management system.

FIG. 4 is a view showing a software constitution of the device.

FIGS. 5A to 5C are explanatory views of management of firmware.

FIGS. 6A to 6C are views showing examples of data managed in a device management service 109.

FIG. 7 is a view showing an example of a task creation screen.

FIG. 8 is a flowchart showing an example of device registration processing in Example 1.

FIG. 9 is another flowchart showing an example of the device registration processing in Example 1.

FIG. 10 is a flowchart showing FW updating task execution processing in Example 1.

FIG. 11 is another flowchart showing the FW updating task execution processing in Example 1.

FIG. 12 is a flowchart showing FW updating processing in Example 1.

FIGS. 13A and 13B are explanatory views of data structures for respective FW versions.

FIG. 14 is an explanatory view of version-up of FW.

FIG. 15 is an explanatory view of version-down of FW.

FIG. 16 is a flowchart showing FW updating task execution processing in Example 2.

FIG. 17 is another flowchart showing the FW updating task execution processing in Example 2.

FIG. 18 is a flowchart showing FW updating processing in Example 2.

FIG. 19 is a flowchart showing an example of device registration processing in Example 3.

FIG. 20 is another flowchart showing an example of the device registration processing in Example 3.

### DESCRIPTION OF THE EMBODIMENTS

### Example 1

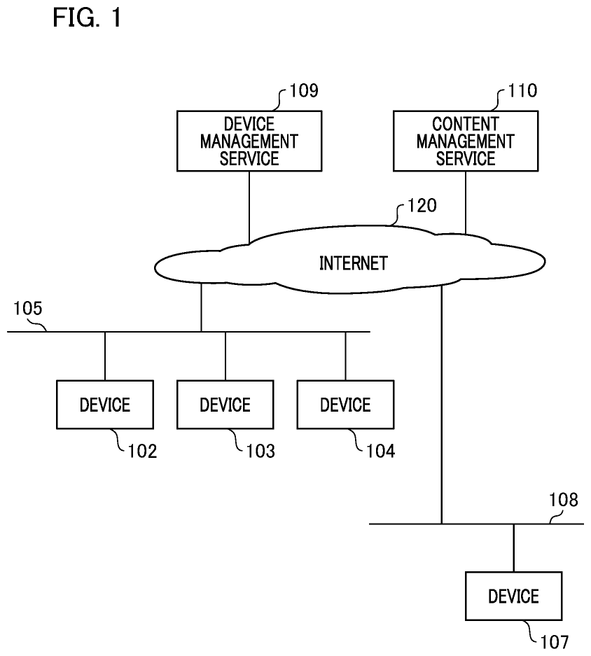

FIG. 1 is a view showing a constitution of a device management system of the present example. The device management system manages a plurality of network devices (management targets) and provides various kinds of services to the network devices. In the present example, a case in which network devices are image processing devices will be described as an example, but the present invention is not limited to this. The network devices need only be instruments which can perform communication. For example, they may be image forming devices, 3D printers, laptop computers, smartphones, smart home appliances, and the like.

A device 102, a device 103, a device 104, and a device 107 are devices managed in the device management system. The device 102, the device 103, the device 104, and the device 107 are devices which can perform network communication. For example, they are multifunction peripherals (MFP) having a printing function and a scanning function. The devices need only be able to communicate with the device management system, and they may be single-function printers having only a printing function. The device 102, the device 103, and the device 104 are connected to a LAN 105. Meanwhile, the device 107 is connected to a LAN 108. The LAN 105 and the LAN 108 are connected to an Internet 120. In the present example, an example in which a LAN is utilized as a network between the Internet 120 and the devices will be described, but a network need only be constituted to be able to transmit and receive data, and any communication method may be adopted. For example, it may be constituted using any of a cellular network such as LTE or 5G, a wireless network, a telephone line, a dedicated digital line, and the like, or a combination of these.

The device management system is a cloud service (which will hereinafter be stated as a CS) having the device management service 109 and the content management service 110. The cloud service is realized by a virtual machine utilizing resources provided by a datacenter including an information processing device. A device management service 109 executes registration processing of an management target device with respect to the device management system or manages various kinds of information on devices. A content management service 110 manages contents such as firmware (which will hereinafter be stated as FW) of devices and extended applications. In the present example, an example in which the device management service 109 and the content management service 110 are realized as separate services will be described, but they may be realized within the same service. Each of the devices connected to the LAN 105 and the LAN 108 is connected to the device management service 109 and the content management service 110 of the device management system via the Internet 120. In the present example, an example in which a device management system is realized by a cloud service has been described, but it may be realized by an information processing device such as one or a plurality of servers.

In the device management system, devices are managed for each tenant (units of user group). Data acquired by the device management service 109 from each device is saved in a dedicated storage domain for each tenant. The data saved in the storage domain of each tenant can be referred to by only the user or the device of the corresponding tenant. For example, it is assumed that the devices 102 to 104 are affiliated with a tenant 1 on the device management service 109 and the device 107 is affiliated with a tenant 2. In this case, the devices 102 to 104 can access only the data of the tenant 1 but cannot access the data of the tenant 2. Similarly, the device 107 can access only the data of the tenant 2 but cannot access the data of the tenant 1.

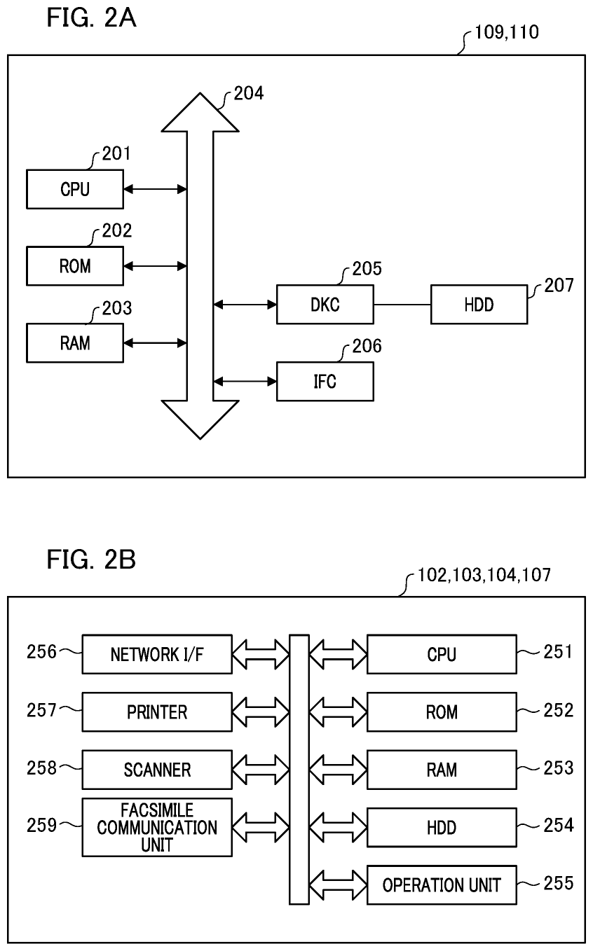

FIGS. 2A and 2B are views showing an information processing device and a hardware constitution of devices. FIG. 2A is a view showing a hardware constitution of the information processing device providing a device management service. That is, FIG. 2A is an example of the information processing device providing the device management service 109 and the information processing device providing the content management service 110. The information processing device has a CPU 201, a ROM 202, a RAM 203, a DKC 205, and an IFC 206. In addition, an HDD 217 may be mounted in the information processing device.

The central processing unit (CPU) 201 is a main constituent for execution on the hardware and controls the information processing device in its entirety. The read only memory (ROM) 202 is a memory dedicated to reading data and stores a basic control program and the like of the information processing device, for example. The random access memory (RAM) 203 is a memory capable of reading and writing data. For example, the RAM 203 functions as a work area or the like of the CPU 201. The disk controller (DKC) 205 controls access to storage devices such as an HDD 207. A hard disk drive (HDD) 212 is an example of a storage device and stores various kinds of programs, data, and the like. In the present embodiment, an example in which an information processing device includes the HDD 207 as a storage device will be described, but the present invention is not limited to this. For example, other storage devices such as an SSD or a disk drive into which external media are loaded may be used. The interface controller (IFC) 206 transmits and receives information with respect to other network devices via a network. Each of the constituent elements is disposed on a system bus 204. The CPU 201 comprehensively controls each of the constituent elements connected to the system bus 204 by executing a program for controlling the information processing device stored in the ROM 202 or the HDD 207. The information processing device may have inputting and outputting means for realizing an input by a user or an output to a user. For example, the information processing device may have a keyboard, a pointing device, and the like as an inputting means and may have a display and the like as an outputting means.

FIG. 2B is a view showing a hardware constitution of device 102, the device 103, the device 104, and the device 107 (image processing devices). The image processing device has a CPU 251, a ROM 252, a RAM 253, an HDD 254, an operation unit 255, a network I/F 256, a printer 257, a scanner 258, and a facsimile communication unit 259. The CPU 251 controls the image processing device in its entirety. The ROM 252 is a memory dedicated to reading data and stores a basic control program and the like of the image processing device and data, for example. The data stored in the ROM 252 includes the serial number and model information of the image processing device, for example. The RAM 253 is a memory capable of reading and writing data and functions as a work area or the like of the CPU 251. In addition, the RAM 253 is also used as a reception buffer and for image drawing. The HDD 254 is an example of a storage device and stores various kinds of programs, data, and the like. For example, the HDD 254 records FW, an extended application, font data, and the like.

The operation unit 255 performs displaying with respect to a user and receives an operation from a user. For example, the operation unit 255 may be constituted of various kinds of switches, buttons, and a liquid crystal display unit for displaying messages or may be constituted of a touch panel. A GUI can be constituted as if a user could directly operate a screen displayed on the touch panel by associating input coordinates and display coordinates in the touch panel with each other. The network I/F 256 is a network interface for connection to a network, and information is transmitted and received with respect to other network devices and a cloud service via the network. The printer 257 performs printing on recording paper. For example, the printer 257 prints documents read by a reader or image data stored in the HDD 254 or prints image data on the basis of a printing job received from an external device. The scanner 258 optically reads documents set in a document holder or an auto document feeder (ADF) and converts it into electronic data. The facsimile communication unit 259 transmits and receives a facsimile. Each of these constituent elements is disposed on a system bus 260. The CPU 251 comprehensively controls each of the constituent elements connected to the system bus 260 by executing a program for controlling the image processing device stored in the ROM 252 or the HDD 255.

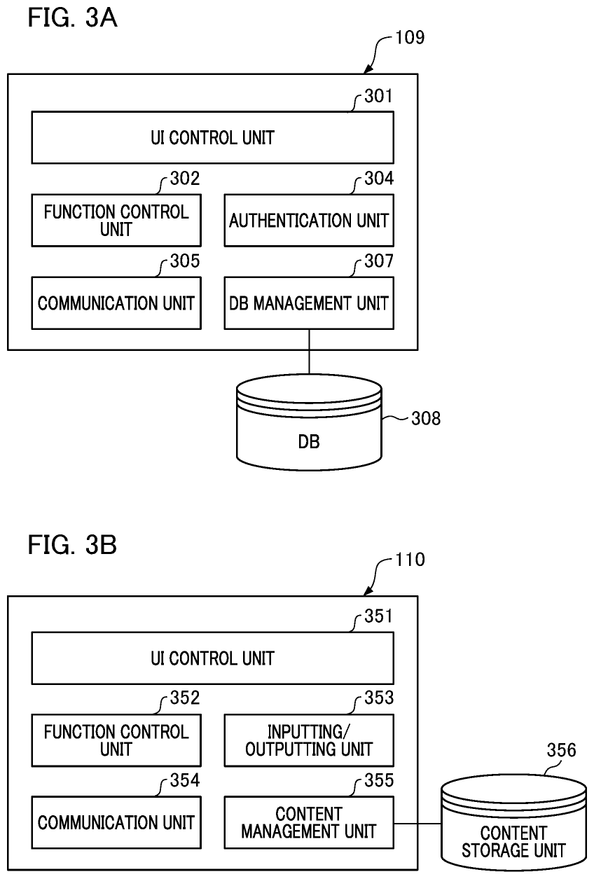

FIGS. 3A and 3B are views showing software constitutions of a device management system. FIG. 3A is a view showing a software constitution of the device management service 109. The software constitution of the device management service 109 is realized by the CPU 201 of the device management service 109 executing the program stored in the ROM 202 or the HDD 207 in the RAM 203. The device management service 109 has a UI control unit 301, a function control unit 302, an authentication unit 304, a communication unit 305, and a DB management unit 307.

The UI control unit 301 provides a graphical user interface for a user operating this program. The graphical user interface is constituted as a web page which can be displayed in other client terminals using a hypertext transfer protocol (HTTP). The graphical user interface may be constituted to be displayed in a display provided in the device management service 109.

The function control unit 302 instructs various kinds of processing with respect to each of the functions inside the device management service 109 in response to an instruction of the UI control unit 301 or a request received by the communication unit 305. In the present example, the function control unit 302 functions as a generating means for generating a registration code, which will be described below. In addition, the function control unit 302 registers and manages device information including the registration code, task information, authentication information, and the like in a table managed by the DB management unit 307. In addition, the function control unit 302 functions as a transmitting means for transmitting information including the registration code to an management target device by controlling the communication unit 305, and a means for controlling validity and invalidity of communication with the devices on the basis of information received from the devices and management information. The function control unit 302 functions as a restoring means for restoring communication between the devices and the device management system by making communication with the devices valid on the basis of information received from the devices and management information. The authentication unit 304 performs authentication processing for a user who has requested to log into the device management service 109. For example, the authentication unit 304 performs user authentication processing by utilizing user information for each tenant saved in a DB 308.

The communication unit 305 controls communication with external devices. For example, the communication unit 305 receives a request from the device 102 (management target) and the like and transmits request contents to the function control unit 302. Moreover, the communication unit 305 receives a processing result with respect to a request from the device 102 and the like from the function control unit 302, creates response data with respect to the request, and transmits a response to the request transmission source. In addition, the communication unit 305 controls HTTP communication and transmits a web page received from the UI control unit 301 to a client terminal utilized by a manager or the like of the device managed in the device management service 109. The DB management unit 307 instructs various kinds of settings with respect to the DB 308 and processing of storing, deleting, updating, and acquiring user information and the like in response to an instruction of the function control unit 302. In addition, the DB management unit 307 manages the table of various kinds of information used by the device management service 109. For example, the DB management unit 307 of the present example manages the device information including the registration code of the device and the task information. The DB 308 is a database retaining various kinds of data and various kinds of tables of the device management service 109. The data retained in the DB 308 is managed for each tenant. A user can only access the data of the tenant having him/her affiliated therewith, and access to data of other tenants is restricted.

FIG. 3B is a view showing a software constitution of the content management service 110. The software constitution of the content management service 110 is realized by the CPU 201 of the content management service 110 executing the program stored in the ROM 202 or the HDD 207 in the RAM 203. The content management service 110 has a UI control unit 351, a function control unit 352, an inputting/outputting unit 353, a communication unit 354, and a content management unit 355.

The UI control unit 351 provides a graphical user interface for a user operating this program. The graphical user interface is constituted as a web page which can be displayed in other client terminals using an HTTP. The graphical user interface may be constituted to be displayed in a display provided in the content management service 110.

The function control unit 352 instructs various kinds of processing with respect to each of the functions inside the content management service 110 in response to an instruction of the UI control unit 351 or a request received by the communication unit 354. The inputting/outputting unit 353 controls inputs and outputs of contents in response to an instruction of the function control unit 352. The communication unit 354 controls communication with external devices. For example, the communication unit 354 receives a request from the device 102 or the device management service 109 and transmits request contents to the function control unit 352. In addition, the communication unit 354 receives a processing result with respect to a request from the function control unit 352, creates response data with respect to the request, and transmits a response to the request transmission source. In addition, the communication unit 354 controls HTTP communication and transmits a web page received from the UI control unit 351 to a client terminal utilized by a manager or the like of the device managed in the content management service 110.

The content management unit 355 instructs processing of storing, deleting, updating, and acquiring contents with respect to a content storage unit 356 in response to an instruction of the function control unit 352. The content storage unit 356 is a database operated in the content management service 110. For example, the content storage unit 356 stores contents such as FW of each version utilized in the devices, and extended applications.

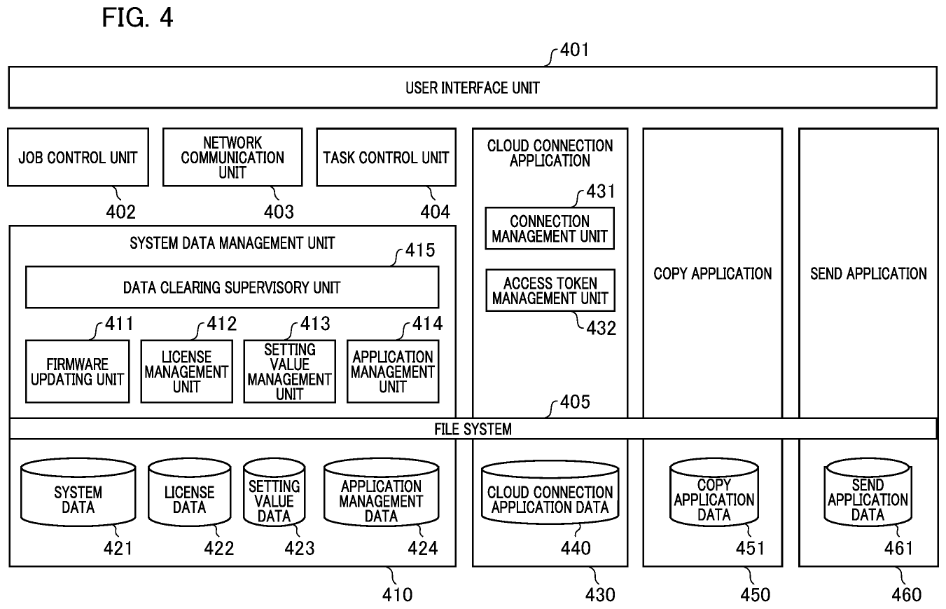

FIG. 4 is a view showing a software constitution of the device. FIG. 4 shows a software constitution of the device 102, the device 103, the device 104, and the device 107 (image processing devices). Each device has a UI unit 401, a job control unit 402, a network communication unit 403, a task control unit 404, a system data management unit 410, a file system 405, and applications. In the present example, an example in which each device has a cloud connection application 430, a copy application 450, and a send application 460 as applications has been described, but it may have more applications.

The user interface (UI) unit 401 displays a screen with respect to the operation unit 255 and notifies the inside of the system of interaction from a user. The job control unit 402 is a module for controlling printing, scanning, and the like while communicating with the printer 257 and the scanner 258 in accordance with an instruction of a user or received data. The network communication unit 403 is a module for controlling network communication with an external device or a cloud service via the network I/F 256. The task control unit 404 is a module for executing a task sent from the device management service 109. In addition, the task control unit 404 also functions as an acquiring means for acquiring a task and a registration code from the device management service 109 via the network communication unit 403.

The file system 405 reads and writes non-volatile data retained inside the device in the HDD 254. The data retained inside the device is managed by the system data management unit 410 in accordance with the kind of data. That is, the system data management unit 410 functions as a managing means for managing diverse data including FW and registration codes. The system data management unit 410 has a data clearing supervisory unit 415, a firmware updating unit 411, a license management unit 412, a setting value management unit 413, and an application management unit 414.

The firmware updating unit 411 manages system data such as FW. The system data managed by the firmware updating unit 411 is retained in a system data 421. In addition, data such as the registration code which has not been cleared by the data clearing supervisory unit 415 during updating of firmware is also saved in a temporary archive domain of the system data 421. The license management unit 412 manages license information for the function activated by a license. The license information managed by the license management unit 412 is retained in license data 422. The setting value management unit 413 manages setting values (configuration information). The setting values managed by the setting value management unit 413 are retained in setting value data 423. The application management unit 414 manages the applications installed in the devices. The applications managed by the application management unit 414 are retained in application management data 424.

An operation domain and a storage domain are individually prepared for the applications installed via the application management unit 414, and each application individually retains unique data of itself. In the present example, an operation domain and a storage domain are individually prepared for each of the cloud connection application 430, the copy application 450, and the send application 460. The cloud connection application 430 retains the unique data in cloud connection application data 440. The copy application 450 retains the unique data in copy application data 451. The send application 460 retains the unique data in send application data 461.

The copy application 450 and the send application 460 are system applications. The system application is pre-installed in the system and is integrated with FW. The copy application 450 is an application providing a copy function. The send application 460 is an application providing a send function of network-transmitting scanning data. In addition to the pre-installed applications, the applications also include extended applications that are applications which may be able to be installed in the devices later via the application management unit 414.

The cloud connection application (which will hereinafter be stated as a connection application) 430 is an application which may be pre-installed in FW or may be distributed later in a form of an extended application. The connection application 430 manages connection with the device management system. The connection application 430 has for managing whether to connect the cloud a connection management unit 431 and an access token management unit 432. The connection management unit 431 manages a connection relationship for providing a service with the device management system using the registration code and functions as a restoring means for restoring the connection relationship when the connection relationship is undone.

The data clearing supervisory unit 415 of the system data management unit 410 can instruct and execute data clearing of data managed by the system data management unit 410 and data managed by each application. The data clearing supervisory unit 415 can instruct deletion of all data such as formatting of the HDD 254 and can also instruct partial clearing of acting on the management unit of each piece of data and performing only necessary clearing.

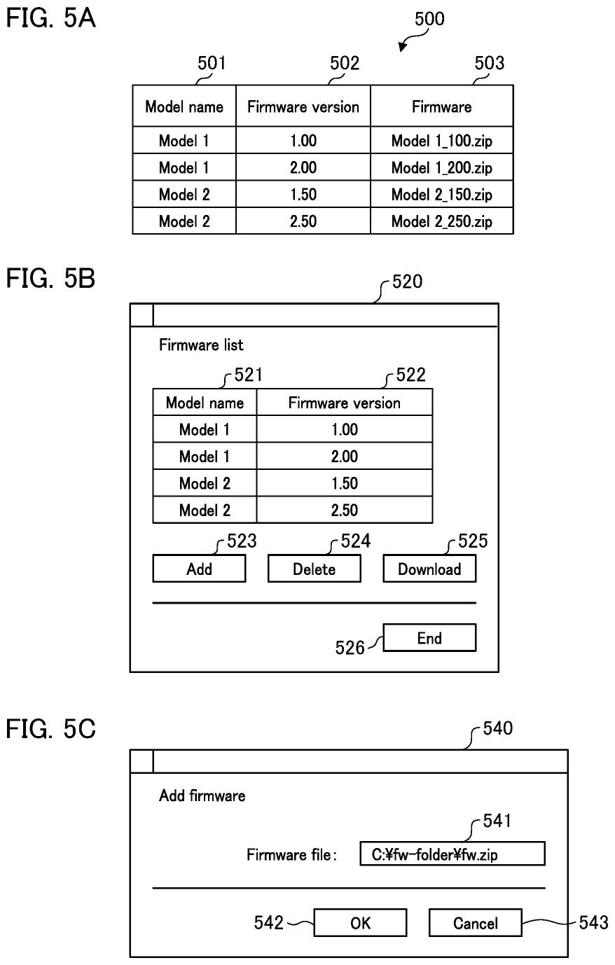

FIGS. 5A to 5C are explanatory views of management of firmware. FIG. 5A is a view showing an example of a firmware management table 500 managed in the content management service 110. The firmware management table 500 is a table storing firmware information (information related to FW). One record indicates one piece of firmware information. Each record in the firmware management table 500 includes model names 501, firmware versions 502, and firmware 503.

In the model names 501, model names of models to which the FW registered in the firmware management table 500 can be applied are stored. In the firmware versions 502, FW version information registered in the firmware 503 is stored. In the firmware 503, entities of the FW registered in the content management service 110 are stored. In the present example, it is assumed that entities of the FW are stored in the firmware 503, but only passwords to the entities of the FW may be stored in the firmware 503. When only passwords are stored in the firmware 503, the entities of the FW are constituted to be located in another place as a file.

FIG. 5B is a view showing an example of a firmware list screen 520. The firmware list screen 520 is a screen provided by the UI control unit 351 of the content management service 110. In the firmware list screen 520, a firmware list and various kinds of buttons are displayed. Specifically, in the firmware list screen 520, model names 521, firmware versions 522, an addition button 523, a deletion button 524, a download button 525, and an end button 526 are displayed.

In the firmware list, the model names 521 and the firmware versions 522 of respective pieces of FW are displayed. For the model names 521 and the firmware versions 522, the values of the model names 501 and the firmware versions 502 of the firmware management table 500 are respectively displayed. The addition button 523 is a button for adding firmware. If the addition button 523 is pressed, an addition screen 540 shown in FIG. 5C is displayed. The deletion button 524 is a button for deleting selected firmware information. If a user selects an arbitrary row in the firmware list and presses the deletion button 524, the data of the record in the firmware management table 500 corresponding to the selection of the user is deleted.

The download button 525 is a button for downloading selected firmware. If a user selects an arbitrary row in the firmware list and presses the download button 525, the firmware of the record in the firmware management table 500 corresponding to the selection of the user is downloaded to the device. The end button 526 is a button for ending display of the firmware list. If the end button 526 is pressed by a user, the UI control unit 351 of the content management service 110 ends the firmware list screen 520.

FIG. 5C is a view showing an example of the addition screen 540. The addition screen 540 is a screen provided by the UI control unit 351 of the content management service 110. In the addition screen 540, a firmware file designation domain 541, an OK button 542, and a cancellation button 543 are displayed. The firmware file designation domain 541 is a domain in which a file password to the entity of the FW added to the content management service 110 is input. In order to facilitate inputting of the file password, a file reference dialogue display button (not shown) may be prepared. If the OK button 542 is pressed in a state in which the file password is input to the firmware file designation domain 541, the content management service 110 adds the FW designated by the firmware file designation domain 541 to the firmware management table 500. At this time, the content management service 110 identifies the model name and the firmware version of the FW from attribute information and the like of the FW, sets them to the model name 501 and the firmware version 502 in the firmware management table 500, and registers the FW in the firmware 503. If addition of the FW is completed, the UI control unit 351 ends the addition screen 540. The cancellation button 543 is a button for ending the addition screen 540. If the cancellation button 543 is pressed by a user, the content management service 110 discards an edition result of the addition screen 540, and the UI control unit 351 ends the addition screen 540. In FIGS. 5A to 5C, an example has been described regarding management of FW by the content management service 110. However, the content management service 110 can also manage extended applications as well as FW.

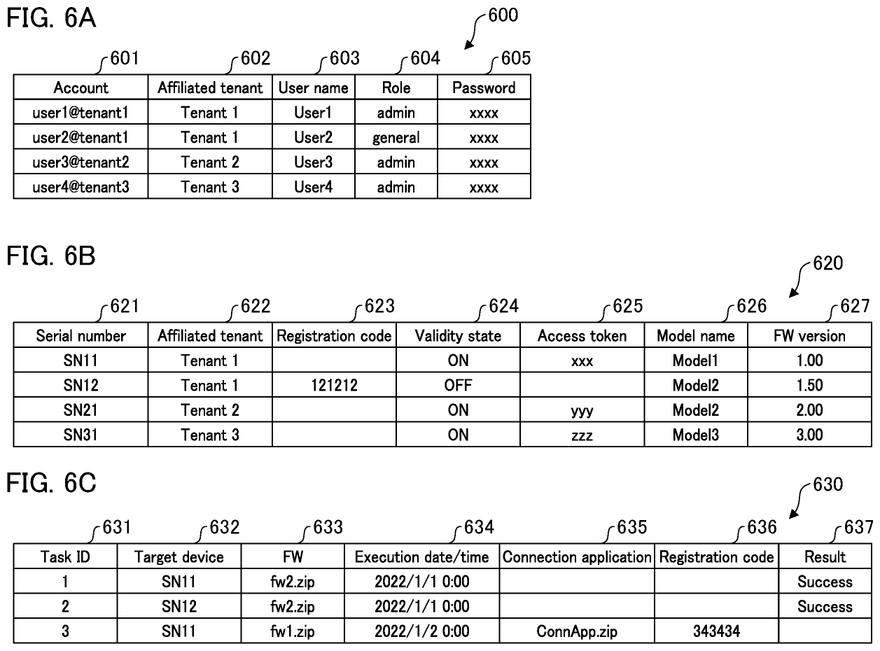

FIGS. 6A to 6C are views showing examples of data managed by the device management service 109. FIG. 6A is an authentication information management table 600. In the authentication information management table 600, authentication information on a user (manager) utilizing the device management service 109 is managed. One record of the authentication information management table 600 indicates one piece of authentication information. The authentication information management table 600 is managed by the DB management unit 307. Each record of the authentication information management table 600 includes an account 601, an affiliated tenant 602, a user name 603, a role 604, and a password 605.

In the accounts 601, IDs for uniquely distinguishing users who access the device management system are stored. In the affiliated tenants 602, information on tenants having users affiliated therewith is stored. In the user names 603, user's names are stored. In the roles 604, roles allocated to users are stored. A role indicates the presence or absence of manager authority. For example, in the present example, values showing either “admin” indicating that the user has manager authority within a tenant or “general” indicating that the user is a general user are stored in the roles 604. There is a need for an account having at least one “admin” role, that is, manager authority to be affiliated with each tenant. The passwords 605 are passwords which are input when users log into the device management system. The device management service 109 of the present example performs user authentication processing on the basis of a combination of an account and a password input by a user attempting to log into the device management system. A method for user authentication is not limited to this, and authentication utilizing the information stored in an IC card or biometric authentication may be performed.

FIG. 6B is a device management table 620. In the device management table 620, information of the device managed in the device management system is managed. One record of the device management table 620 indicates one piece of device information. The device management table 620 is managed by the DB management unit 307. Each record of the device management table 620 includes a serial number 621, an affiliated tenant 622, a registration code 623, a validity state 624, an access token 625, a model name 626, and an FW version 627.

In the serial numbers 621, serial numbers of the devices are stored. In the affiliated tenants 622, values of the tenants having the devices affiliated therewith are stored. In the registration codes 623, registration codes utilized at the time of registration of the devices are stored. A registration code is a character string input by a user when a new device is registered in the device management system. For example, a registration code is generated based on a particular algorithm using the serial number or the time at which a registration operation is executed, but the method for generating a registration code is not limited to this.

In the validity states 624, values indicating whether cloud connection of the device is valid are stored. In the present example, “ON” is stored when cloud connection is valid and “OFF” is stored when it is invalid, but the form is not limited to this. When the validity state is “OFF”, and when there is no access of the device using the value of the registration code 623 for a certain period of time, the value of the registration code 623 becomes invalid and is deleted.

In the access tokens 625, access tokens used when the devices access the device management system are stored. Regarding an access token, a different value is generated for each device based on a particular algorithm. In the model names 626, model names of the devices are stored. In the FW versions 627, current FW versions of the devices are stored. The device management table 620 can include device names, network information such as IP addresses of the devices, and the like.

FIG. 6C is a task management table 630. In the task management table 630, task information managed in the device management system is managed. A task is processing executed in the device registered in the device management system. In the present example, an example in which processing of updating the FW of the device is managed in the task management table 630 will be described. One record of the task management table 630 indicates one piece of task information. The task management table 630 is managed by the DB management unit 307. Each record of the task management table 630 includes a task ID 631, a target device 632, FW 633, an execution date/time 634, a connection application 635, a registration code 636, and a result 637.

In the task IDs 631, information uniquely distinguishing the tasks is stored. In the example shown in FIG. 6C, numbers starting from 1 are stored in the task IDs 631, but the form is not limited to this. In the target devices 632, target devices for the tasks, that is, information uniquely distinguishing the devices having the FW is updated is stored. In the example shown in FIG. 6C, the serial numbers of the devices are stored in the target devices 632, but the form is not limited to this.

In the FW 633, FW for updating is stored. In the example shown in FIG. 6C, the entities of the FW are stored in the FW 633, but the form is not limited to this. For example, the passwords to the entities of the FW may be stored. In the execution date/times 634, date/time information on execution of the tasks is stored. In the connection applications 635, extended application-type connection applications installed in the devices when cloud connection of the target device 632 becomes invalid after the task is executed and the updating target FW is applied are stored. In the example shown in FIG. 6C, it is assumed that entities of the connection applications are stored in the connection applications 635, but the form is not limited to this, and passwords to the entities of the connection applications may be stored.

In the registration codes 636, when cloud connection of the target device 632 becomes invalid after the task is executed and the updating target FW is applied, a registration code for reconnection to the device management system is stored. In the results 637, execution results of the tasks are stored. After the task is executed, “success” is stored in the results 637 when execution of the task succeeds and “fail” is stored therein when it fails. Before the task is executed, the result 637 is blank.

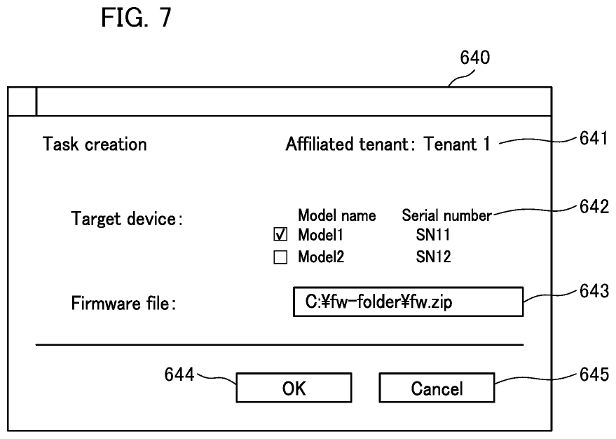

FIG. 7 is a view showing an example of a task creation screen. A task creation screen 640 is a UI screen utilized by a user of each tenant of the device management service 109 to instruct FW updating with respect to the device registered in the affiliated tenant. The task creation screen 640 is provided by the UI control unit 301 of the device management service 109. The task creation screen 640 includes an affiliated tenant 641, a target device designation domain 642, a FW designation domain 643, an OK button 644, and a cancellation button 645.

The affiliated tenant 641 is a name of the affiliated tenant corresponding to a user. In the affiliated tenant 641, a value of the affiliated tenant 602 associated with the account used when a user logs into the device management service 109 is displayed. In the example shown in FIG. 7, “Tenant 1” is displayed in the affiliated tenant 641. The target device designation domain 642 is a domain displaying the device corresponding to the tenant in a selectable manner. In the example shown in FIG. 7, values of the serial number 621 and the model name 626 are displayed as information for distinguishing the device, but other information may be displayed as long as it is information with which a user can distinguish the device. A user selects and designates the device to be subjected to updating of the FW in the target device designation domain 642.

The FW designation domain 643 is a domain in which the file password to the entity of the FW applied to the device to be updated with the FW is input. In the FW designation domain 643, a user inputs the file password to the entity of the FW to be applied to the target device designated in the target device designation domain 642. The file of the entity of the FW may be a file downloaded from the firmware list screen 520 or may be an FW file obtained by other means. In order to facilitate an input to the FW designation domain 643, a file reference dialogue display button (not shown) may be prepared.

The OK button 644 is a button for executing updating of the FW with respect to the device designated in the target device designation domain 642 and the FW designation domain 643. If the OK button 644 is pressed, the device management service 109 adds a new record of task information in accordance with designated contents in the task creation screen 640 to the task management table 630. Specifically, the device management service 109 stores the device information designated in the target device designation domain 642 in the target device 632 of the newly added record and stores the FW file designated in the FW designation domain 643 in the FW 633. Moreover, the device management service 109 registers the time when the OK button 644 is pressed in the execution date/time 634 of the record. Instead of the time when the OK button 644 is pressed, a time designated by a user may be registered in the execution date/time 634 of the record. If addition of a new record in accordance with designated contents in the task creation screen 640 to the task management table 630 is completed, the device management service 109 ends the task creation screen 640. The cancellation button 645 is a button for canceling creation of a task. If the cancellation button 645 is pressed, the device management service 109 discards the edition result of the task creation screen 640 and ends the task creation screen 640.

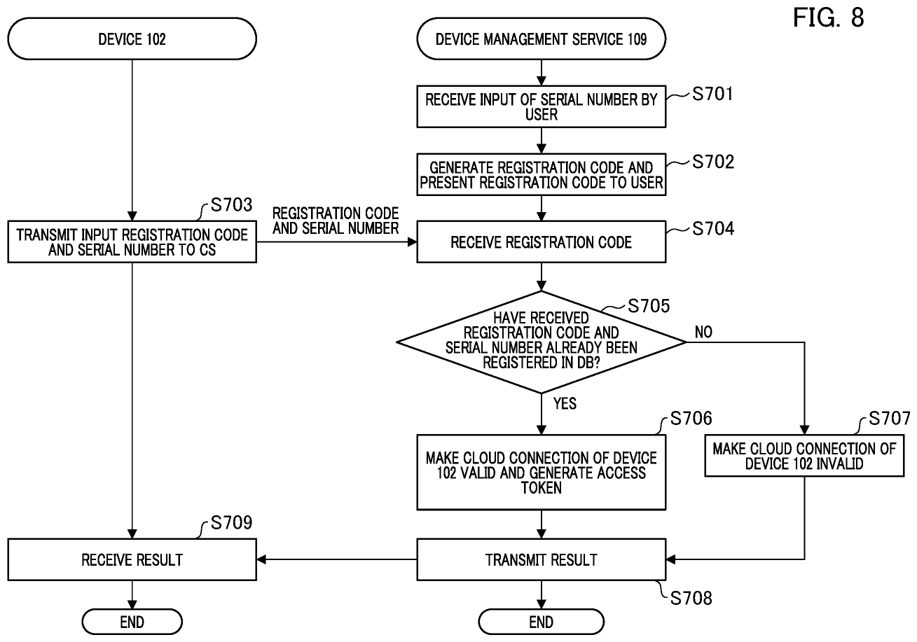

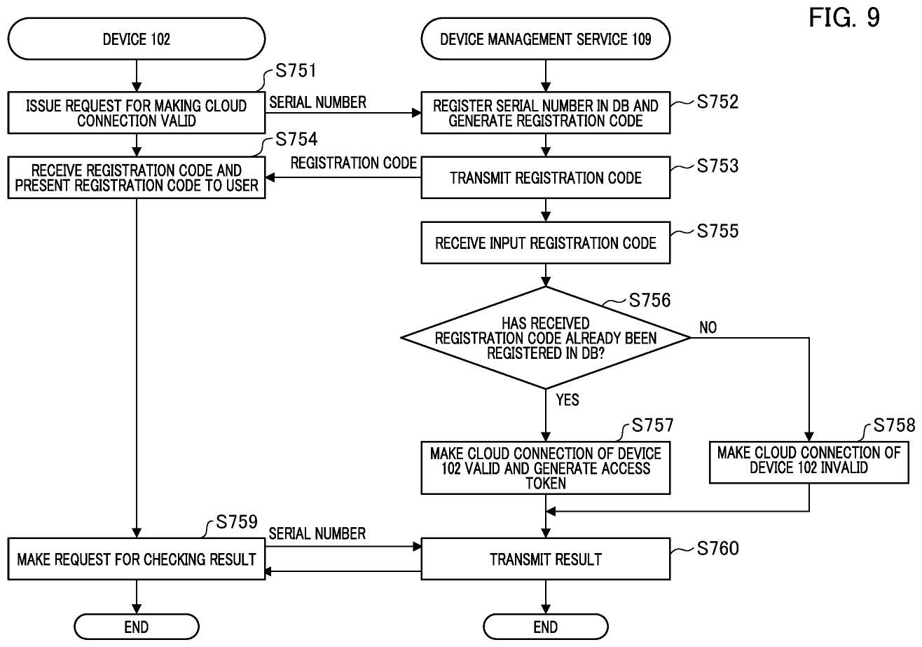

Next, device registration processing will be described using FIGS. 8 and 9. The device registration processing is processing of registering the management target device in the device management system. Each step of processing executed by the device in the device registration processing is realized by the CPU 251 executing a program stored in the memory (the ROM 252 or the HDD 255). Each step of processing executed by the device management system in the device registration processing is realized by the CPU 201 of the device management service 109 executing a program stored in the memory (the ROM 202 or the HDD 207).

Hereinafter, a case in which the device 102 is registered in the device management system will be described as an example. First, using FIG. 8, a case in which a user starts the processing of registering a device in the screen provided by the UI control unit 301 of the device management service 109 in the information processing device (not shown) and the like will be described. FIG. 8 is a flowchart showing an example of device registration processing in Example 1. The device registration processing shown in FIG. 8 is started when a user registering a device inputs the serial number of the registration target device in the screen generated by the UI control unit 301 of the device management service 109 after the user logs into the device management service 109. In S701, the UI control unit 301 of the device management service 109 receives the serial number of the device input by the user and delivers it to the function control unit 302. The function control unit 302 stores the received serial number of the device and the affiliated tenant of the user in the serial number 621 of the device management table 620 and the affiliated tenant 622 managed by the DB management unit 307. The function control unit 302 acquires the affiliated tenant of the user from the affiliated tenant 602 of the authentication information management table 600.

In S702, the function control unit 302 of the device management service 109 generates a registration code and presents it to the user. Specifically, first, the function control unit 302 generates a registration code and stores it in the registration code 623 of the device management table 620 managed by the DB management unit 307. In addition, the function control unit 302 stores “OFF” indicating that cloud connection is invalid in the validity state 624 of the device management table 620. Thereafter, the function control unit 302 delivers the generated registration code to the UI control unit 301. The UI control unit 301 displays the registration code received from the function control unit 302 in the screen generated by the UI control unit 301. The user inputs the registration code displayed in the screen through the screen generated by the UI unit 401 of the device 102.

In S703, the connection management unit 431 of the connection application 430 of the device 102 transmits the registration code and the serial number of the device 102 input by the user to the device management service 109. Specifically, the UI unit 401 receives the registration code input by the user in the screen displayed by the UI unit 401 and delivers it to the connection management unit 431 of the connection application 430. The connection management unit 431 acquires the serial number of itself from the system data 421 and transmits the registration code and the serial number of itself to the device management service 109 via the network communication unit 403.

In S704, the function control unit 302 of the device management service 109 receives the serial number and the registration code from the device 102 via the communication unit 305. In S705, the function control unit 302 of the device management service 109 judges whether or not the serial number and the registration code received from the device 102 have already been registered in the device management table 620 managed by the DB management unit 307. When it is judged that the serial number and the registration code received from the device 102 have already been registered in the device management table 620, the processing of S706 is performed. Meanwhile, when it is judged that the serial number and the registration code received from the device 102 have not already been registered in the device management table 620, the processing of S707 is performed.

In S706, the function control unit 302 of the device management service 109 makes cloud connection of the device 102 valid and generates an access token. Specifically, the function control unit 302 first sets “ON” for the value of the validity state 624 of the device management table 620 managed by the DB management unit 307. Next, the function control unit 302 generates an access token for distinguishing access to the device management service 109 from the device 102. The function control unit 302 stores the generated access token in the access token 625 of the device management table 620. Moreover, the function control unit 302 deletes the value of the registration code 623 of the device management table 620 which has already been used. In S707, the function control unit 302 of the device management service 109 makes cloud connection of the device 102 invalid. Specifically, the function control unit 302 sets “OFF” for the value of the validity state 624 of the device management table 620. When the value of the validity state 624 is “OFF”, there is no need to set anything.

In S708, the function control unit 302 of the device management service 109 transmits the result of the device registration processing to the device 102 via the communication unit 305. When the access token is generated in S706, the function control unit 302 also transmits the access token together with the result of the device registration processing to the device 102. In S709, the connection management unit 431 of the connection application 430 of the device 102 receives the result of the device registration processing from the device management service 109 via the network communication unit 403. When cloud connection is made valid, the fact that cloud connection has been made valid is stored in the cloud connection application data 440. In addition, when the access token is received, the received access token is stored in the access token management unit 432. The access token is used at the time of access to the device management system thereafter.

Next, using FIG. 9, a case in which a user starts the processing of registering a device by operating the device to be registered will be described. FIG. 9 is another flowchart showing an example of the device registration processing in Example 1. The device registration processing shown in FIG. 9 is started when a user registering a device instructs cloud connection in the screen generated by the UI unit 401 of the device 102. In S751, the UI unit 401 of the device 102 transmits a request for making cloud connection valid to the device management service 109 of the device management system. Specifically, first, the UI unit 401 calls the connection management unit 431 upon reception of an instruction of cloud connection by a user. The connection management unit 431 acquires the serial number of itself from the system data 421 and transmits the acquired serial number to the device management service 109 via the network communication unit 403. Here, it is assumed that the uniform resource locator (URL) of the device management service 109 is incorporated into the connection management unit 431 of the device 102 in advance, but it may be provided by a different means such as an input by a user.

In S752, if the function control unit 302 of the device management service 109 receives the serial number of the device 102 via the communication unit 305, it stores the received serial number in the serial number 621 of the device management table 620. Moreover, the function control unit 302 generates a registration code and stores it in the registration code 623 of the device management table 620. In addition, the function control unit 302 stores “OFF” indicating that cloud connection is invalid in the validity state 624 of the device management table 620. In S753, the function control unit 302 of the device management service 109 transmits the registration code generated in S752 to the device 102 via the communication unit 305.

In S754, the connection management unit 431 of the device 102 receives the registration code from the device management service 109 via the network communication unit 403. Thereafter, the connection management unit 431 delivers the received registration code to the UI unit 401. The UI unit 401 displays the received registration code in the screen generated by the UI unit 401. The user logs into the device management service 109 with the registration code displayed in the screen and inputs it to the screen provided by the UI control unit 301 of the device management service 109. For example, the user inputs it to the screen provided by the UI control unit 301 of the device management service 109 using the information processing device (not shown). When the screen provided by the UI control unit 301 of the device management service 109 in the device 102 can be displayed, the user may log into the device management system in the device 102 and input the registration code.

In S755, the UI control unit 301 of the device management service 109 receives the registration code input by the user and delivers it to the function control unit 302. In S756, the function control unit 302 of the device management service 109 judges whether or not the received registration code has already been registered in the device management table 620. When it is judged that the received registration code has already been registered in the device management table 620, the processing of S757 is performed. Meanwhile, when it is judged that the received registration code has not already been registered in the device management table 620, the processing of S758 is performed.

In S757, the function control unit 302 of the device management service 109 stores the affiliated tenant of the user in the affiliated tenant 622 of the device management table 620. Moreover, the function control unit 302 of the device management service 109 makes cloud connection of the device 102 valid and generates an access token. Since the processing of making cloud connection of the device 102 valid and generating an access token is similar to the processing of S706, description thereof will be omitted. In S758, the function control unit 302 of the device management service 109 makes cloud connection of the device 102 invalid. Since the processing of S758 is similar to that of S707, detailed description thereof will be omitted.

After a certain period of time has elapsed from execution of S754, the device 102 executes the processing of S759. The period of time until execution of S759 from execution of S754 may be incorporated into the connection management unit 431 in advance or may be provided by a different means such as an input by a user. In S759, the connection management unit 431 of the device 102 transmits a result checking request for checking the result of the device registration processing to the device management service 109. Specifically, the connection management unit 431 acquires the serial number of itself from the system data 421, issues a result checking request including the serial number, and transmits the result checking request to the device management service 109 via the network communication unit 403.

In S760, if the function control unit 302 of the device management service 109 receives the result checking request of the device registration processing from the device 102 via the communication unit 305, it responds to the device 102 with the result. Specifically, first, the function control unit 302 checks whether or not cloud connection of the device 102 corresponding to the serial number has become valid on the basis of the serial number included in the received result checking request. The function control unit 302 checks whether or not the received serial number is stored in the serial number 621 of each record of the device management table 620, and when it is stored therein, the function control unit 302 checks whether or not the value of the validity state 624 is “ON”. When the value of the validity state 624 is “ON”, the function control unit 302 acquires the value of the access token 625 and transmits it to the device 102 together with the result indicating the fact that registration processing has succeeded. When the received serial number is not present, or when the value of the validity state 624 is a value other than “ON”, the function control unit 302 transmits the fact that cloud connection is invalid to the device 102. When an access token is received from the device management service 109, the device 102 stores the received access token in the access token management unit 432. The access token is used at the time of access to the device management system thereafter.

In any case using either of the flowcharts in FIGS. 8 and 9, registration of the device 102 in the device management service 109 is completed. Thereafter, the device 102 transmits the device information such as the model name and the FW version to the device management service 109 using the access token stored in the access token management unit 432. The device management service 109 stores the device information received from the device 102 in the model name 626 and the FW version 627 of the device management table 620. The device 102 can transmit a request to the device management service 109 using the access token. In addition, the device 102 can also receive an instruction from the device management service 109 when the device management service 109 performs polling at a regular interval.

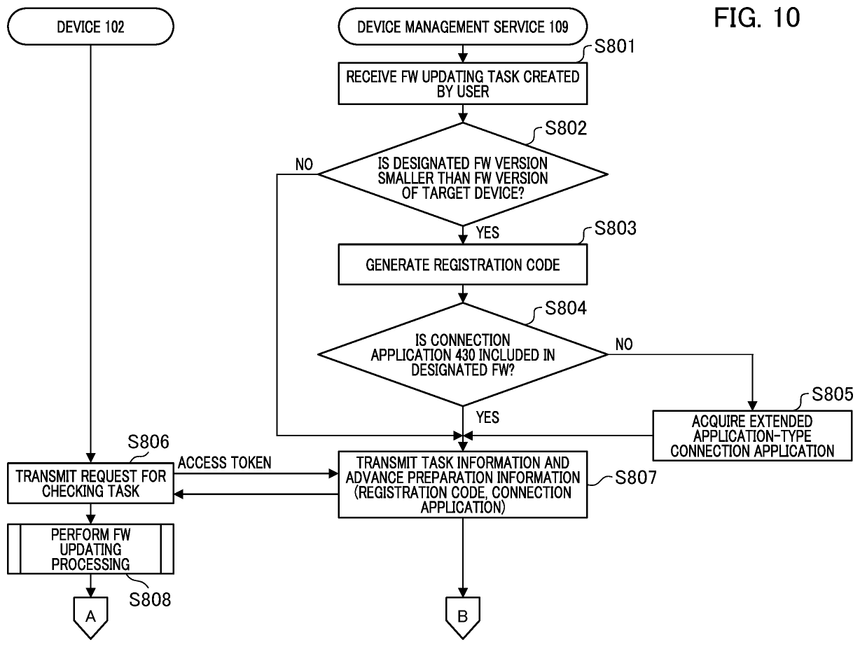

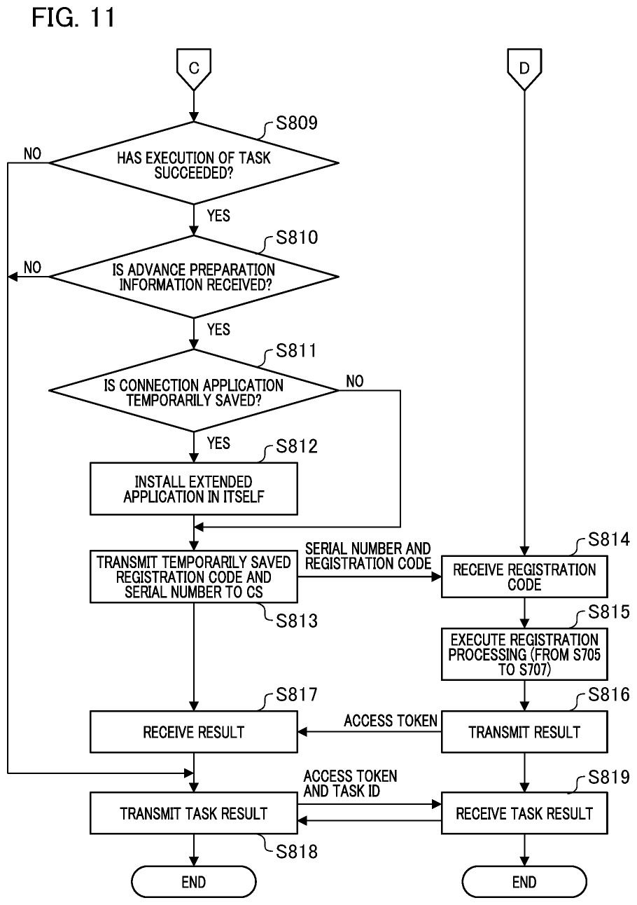

Next, FW updating task execution processing will be described using FIGS. 10 and 11. The FW updating task execution processing in the present example is processing of executing a task of updating the FW of the device. FIGS. 10 and 11 are flowcharts showing FW updating task execution processing in Example 1. Each step of processing executed by the device in the FW updating task execution processing is realized by the CPU 251 executing a program stored in the memory (the ROM 252 or the HDD 255). Each step of processing executed by the device management system in the FW updating task execution processing is realized by the CPU 201 of the device management service 109 executing a program stored in the memory (the ROM 202 or the HDD 207).

Hereinafter, a case of updating the FW of the device 102 will be described as an example. The FW updating task execution processing is started by a user designating an updating target device and FW to be applied and pressing the OK button 644 in the task creation screen 640 provided by the device management system. The device management service 109 first performs task creation preparation in the processing of S801 to S805. In S801, the function control unit 302 of the device management service 109 receives the task information of the FW updating task created by a user in the task creation screen 640 and stores it in the task management table 630. Details of storing processing are as stated in description of the task creation screen 640 using FIG. 7.

In S802, the function control unit 302 of the device management service 109 judges whether or not the FW version designated in S801 is older than the current FW version of the target device. That is, it is judged whether or not the value indicating the FW version designated in S801 is smaller than the value indicating the current FW version of the target device. The processing of S802 is processing executed for determining whether or not FW updating designated by the task is updating of the FW required to restore the connection relationship between the device and the device management system. Generally, a mechanism for initializing various kinds of settings at the time of version-down of the FW is incorporated into the device, and connection between the device and the CS is cancelled during FW updating accompanying version-down of the FW. Further, it is judged whether or not the connection relationship between device and the device management system is cancelled and the updating of the FW is updating of the FW required to be restored by judging whether or not updating of the FW occurred in S802 is version-down of the FW. When it is judged that the value indicating the FW version designated in S801 is smaller than the value indicating the current FW version, that is, when it is judged that the updating of the FW is updating of the FW required to restore the connection relationship between the device and the device management system, the processing of S803 is performed. When it is judged that the value indicating the FW version designated in S801 is not smaller than the value indicating the current FW version, the processing stands by until the request in S806 is received from the device 102. That is, when it is judged that the updating of the FW is not updating of the FW required to restore the connection relationship between the device and the device management system, the processing stands by until the request in S806 is received from the device 102. In the present example, it is judged only whether or not FW updating corresponds to version-down of the FW, but it may be judged whether or not FW updating accompanies initialization of the system data in the device and is version-down of predetermined FW required to restore the connection relationship.

In S803, the function control unit 302 of the device management service 109 generates a registration code of the device 102. The registration code generated in S803 is a code for restoring the connection relationship between the device management system and the device 102. Specifically, if the registration code 623 of the record of the device management table 620 corresponding to the device 102 (updating target) is empty, the function control unit 302 generates a registration code of the target device in a manner similar to that of the processing of S702 and stores it in the registration code 623. However, the function control unit 302 does not change the validity state 624 corresponding to the device 102 as it remains “ON”. In addition, the function control unit 302 also stores the registration code, which is the same as the registration code stored in the registration code 623 of the device management table 620, in the registration code 636 of the task management table 630.

In S804, the function control unit 302 of the device management service 109 judges whether or not the connection application 430 is included in the FW applied to the device 102 designated in S801. For example, it is possible to judge whether or not the connection application 430 is included in the FW when the function control unit 302 retains the module name of the connection application 430 in advance and checks that a module having the same name is included in the entity of the FW. Alternatively, it can also be judged when the function control unit 302 stores a file listing all modules included in the FW in the entity of the FW and checks the presence of the module name of the connection application 430 in the file. In addition, it may be judged whether or not the connection application 430 is included in the FW by a means other than this. When it is judged that the connection application 430 is included in the FW applied to the device 102, the device management service 109 stands by until the request of S806 is received. Meanwhile, when it is judged that the connection application 430 is not included in the FW applied to the device 102, the device management service 109 performs the processing of S805.

In S805, the function control unit 302 of the device management service 109 acquires a connection application that is an extended application which can be installed in the FW applied to the device 102. Specifically, the function control unit 302 first identifies the version of the connection application which can be installed in the FW designated by this task using a combined list of the FW version created in advance and the version of the connection application which can be installed therein. Further, the function control unit 302 acquires the connection application of the identified version from the content management service 110 and stores it in the connection application 635 of the task management table 630. The combined list of the FW version and the version of the connection application which can be installed therein may be retained in the content management service 110. In that case, the function control unit 302 transmits the FW version information designated by this task to the content management service 110, and the content management service 110 identifies the version of the connection application and responds to the device management service 109. Thereafter, the device management service 109 stands by until the request of S806 is received. Through the processing shown in S801 to S805 described above, the task creation preparation by the device management system is completed.

In S806, the task control unit 404 of the device 102 checks the presence or absence of a task in the device management service 109 at a regular interval. When the task creation preparation has ended through the processing of S801 to S805, the device management service 109 responds to S806 and executes S807. Meanwhile, when no task is present, the device management service 109 responds with the result such as “no task”, for example, as a response to S806.

In S807, the function control unit 302 of the device management service 109 transmits the task information and advance preparation information to the device 102. Here, the advance preparation information is information including information of the registration code for restoring the connection relationship between the device management system and the device 102 prepared in advance in S803. In addition, when the connection application is prepared in advance in the processing of S805, information of the registration code and information of the connection application are included in the advance preparation information. The function control unit 302 extracts the task information and the advance preparation information to be instructed to the device 102 from the task management table 630 and transmits it to the device 102. The task control unit 404 of the device 102 receives the task information and the advance preparation information including the registration code from the device management service 109 via the network communication unit 403 and saves them in a temporary saving domain of the system data 421. The task information and the advance preparation information are managed in the temporary saving domain of the system data 421.

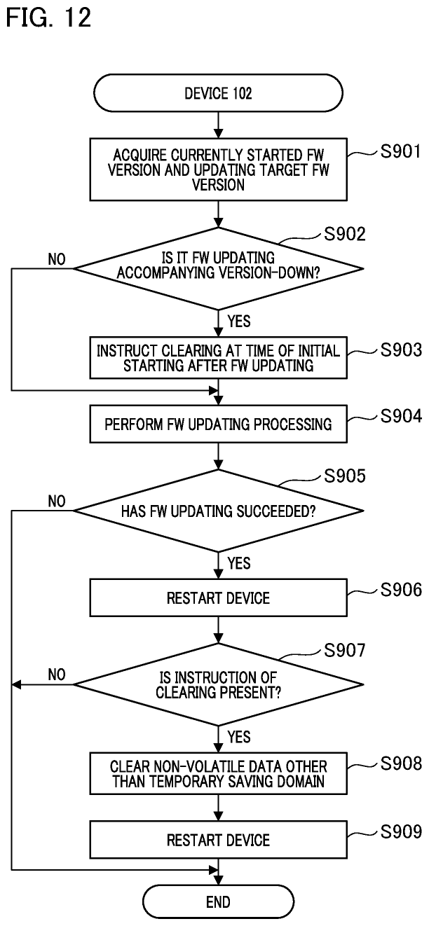

In S808, the task control unit 404 of the device 102 executes the FW updating processing on the basis of the task information received from the device management service 109. Specifically, the task control unit 404 receives the task information from the device management service 109 via the network communication unit 403 and saves it in the temporary saving domain of the system data 421. Further, the task control unit 404 executes the FW updating processing corresponding to the task information. The FW updating processing will be described below using FIG. 12. In S809, the task control unit 404 of the device 102 judges whether or not the FW updating processing of S808 has succeeded. When it is judged that the FW updating processing has succeeded, the task control unit 404 performs the processing of S801. Meanwhile, when it is judged that the FW updating processing has not succeeded, the task control unit 404 performs the processing of S818.

In S810, regarding a response to the task checking request of S806, the task control unit 404 of the device 102 judges whether or not the advance preparation information such as the registration code or the extended application-type connection application has been received from the device management service 109. When it is judged that the advance preparation information has been received, the task control unit 404 performs the processing of S811. Meanwhile, when it is judged that the advance preparation information has not received, the task control unit 404 performs the processing of S818.

In S811, the task control unit 404 of the device 102 judges whether or not an extended-type connection application received as the advance preparation information from the device management service 109 is saved in the temporary saving domain of the system data 421. When it is judged that the extended-type connection application received as the advance preparation information from the device management service 109 is saved in the system data 421, the task control unit 404 performs the processing of S812. Meanwhile, when it is judged that the extended-type connection application received as the advance preparation information from the device management service 109 is not saved in the system data 421, the task control unit 404 performs the processing of S813.

In S812, the task control unit 404 of the device 102 installs the extended-type connection application received as the advance preparation information from the device management service 109 in the device 102. Specifically, first, the task control unit 404 takes out the extended application-type connection application from the temporary saving domain of the system data 421 and delivers it to the application management unit 414. The application management unit 414 installs the received connection application and retains the entity thereof in the application management data 424. Accordingly, the connection application 430 can be continuously disposed in the device 102 itself.

In S813, the connection management unit 431 of the connection application 430 instructed to the task control unit 404 of the device 102 transmits the registration code received from the device management service 109 and the serial number of the device 102 to the device management service 109. Specifically, the connection management unit 431 acquires the registration code received as the advance preparation information from the device management service 109 from the temporary saving domain of the system data 421 and transmits it to the device management service 109 via the network communication unit 403 together with the serial number of itself. In S814, the function control unit 302 of the device management service 109 receives the serial number and the registration code from the device 102 via the communication unit 305.

In S815, the function control unit 302 of the device management service 109 executes registration processing of the device 102 with respect to the device management service 109. In the processing of registering a device in S815, processing similar to that of S705 to S707 of the device registration processing shown in FIG. 8 is executed. In S816, the function control unit 302 of the device management service 109 transmits the result of registration processing to the device 102. The processing of S816 is processing similar to that of S708. In S817, the connection management unit 431 of the connection application 430 of the device 102 receives the result of the device registration processing from the device management service 109 via the network communication unit 403. The processing of S817 is processing similar to that of S709.

In S818, the task control unit 404 of the device 102 transmits the execution result of the task to the device management service 109 via the network communication unit 403 together with the task ID taken out from the temporary saving domain of the system data 421. For example, the task control unit 404 transmits “success” when the FW updating processing has succeeded and transmits “fail” when it has failed. The information transmitted to the device management service 109 by the device 102 in S818 need only be a value with which the device management service 109 can judge whether the execution result of the task in the device 102 has succeeded or failed. In S819, when the task result is received from the device 102 via the communication unit 305, the function control unit 302 of the device management service 109 identifies the corresponding record from the task management table 630 using the received task ID and stores the result of the task in the result 637.

Next, details of the FW updating processing in S808 will be described using FIG. 12. FIG. 12 is a flowchart showing FW updating processing in Example 1. Each step of processing executed by the device in the FW updating processing is realized by the CPU 251 executing a program stored in the memory (the ROM 252 or the HDD 255). Hereinafter, a case in which the device 102 executes the FW updating processing will be described as an example.

In S901, the task control unit 404 checks the FW version currently started in the device 102 and the version of the FW applied through updating (updating target FW). In S902, the task control unit 404 judges whether or not it is FW updating accompanying version-down on the basis of the two versions checked in S901. For example, the task control unit 404 judges that it is FW updating accompanying version-down if the value of the updating target FW version is smaller than the value of the FW version started in the device 102. In addition, the task control unit 404 judges that it is FW updating accompanying version-down even when the advance preparation information such as the registration code or the extended application-type connection application is received from the device management service 109 as a response to the task checking request in S807. When it is judged that the FW updating is FW updating accompanying version-down of the FW, the task control unit 404 performs the processing of S903. Meanwhile, when it is judged that the FW updating is not FW updating accompanying version-down of the FW, the task control unit 404 performs the processing of S904. In the present example, it is judged only whether or not FW updating corresponds to version-down of the FW, but it may be judged whether or not FW updating accompanies initialization of the system data in the device and is version-down of predetermined FW required to restore the connection relationship.

In S903, the task control unit 404 instructs a reservation for special clearing processing of forcibly executing clear processing at the time of first starting after version-down of the FW to the data clearing supervisory unit 415. Reservation information of clearing is archived in a non-volatile domain inside the data clearing supervisory unit 415. In S904, the firmware updating unit 411 performs processing of updating the FW of the device 102 to the FW version instructed from the device management system. Therefore, when updating of the FW which has occurred is version-down of the FW, the task control unit 404 executes version-down after a reservation for clearing is performed.

In S905, the firmware updating unit 411 judges whether or not the FW updating processing of S904 has succeeded. When it is judged that the FW updating processing has succeeded, the firmware updating unit 411 performs the processing of S906. Meanwhile, when it is judged that the FW updating processing has not succeeded, the firmware updating unit 411 ends this processing. In S906, the firmware updating unit 411 restarts the device 102.

In S907, the data clearing supervisory unit 415 judges whether or not an instruction of clearing is present. Specifically, the data clearing supervisory unit 415 judges whether or not reservation information of clearing is present in the non-volatile domain inside the data clearing supervisory unit 415 during starting of the FW after restarting. When it is judged that reservation information of clearing is present in the data clearing supervisory unit 415, the data clearing supervisory unit 415 performs the processing of S908. Meanwhile, when it is judged that reservation information of clearing is not present in the data clearing supervisory unit 415, the data clearing supervisory unit 415 ends this processing.

In S908, the data clearing supervisory unit 415 performs the clear processing. In the clear processing, the data clearing supervisory unit 415 clears non-volatile data other than the data saved in the temporary saving domain. Specifically, the data clearing supervisory unit 415 first performs initialization of the license data 422, the setting value data 423, and the application management data 424. Moreover, the data clearing supervisory unit 415 also performs initialization of data of the system application, such as the copy application data 451 and the send application data 461. The data clearing supervisory unit 415 also performs initialization of the system data 421 but the task information and the advance preparation information saved in the temporary saving domain are maintained without being erased.

In S909, the firmware updating unit 411 restarts the device 102 again. Since a start sequence of S909 begins in a state in which a data group that may be in a starting inconsistent state due to updating of the FW is initialized once by the clear processing of S908, the device 102 is started without causing a startup failure or the like at the time of restarting S909. In this manner, in the present example, during updating of the FW accompanying version-down, the clear processing is executed at the time of initial starting to prevent occurrence of the inconsistent state between the updated FW and the original data. On the other hand, at the time of version-down of the FW, the connection relationship between the device 102 and the device management system is also cleared by the clear processing. Therefore, in the present example, the connection relationship is restored by the processing for reconnection described in FIGS. 10 and 11. Even when version-down of the FW is performed and various kinds of settings are cleared, the device 102 can continue connection with the device management service 109. As a result, a user can check the execution result of the FW updating processing on the device management service 109 without visiting the installation place of the device.

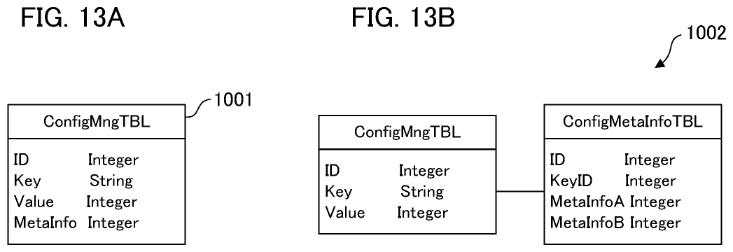

In the present example, the clearing reservation processing (S903) and the clear processing (S908) are executed such that the device does not cause a startup failure due to version-down. However, an example in which the inconsistent state occurring when the clear processing is not executed will be described using FIGS. 13A to 15. FIGS. 13A and 13B are explanatory views of data structures for respective FW versions. Hereinafter, a case in which the FW versions are a version V1.00 and a version V2.00 will be described as an example. The version V2.00 is developed after V1.00 in time series, and version-up from the version V1.00 is assumed and created. A table schema 1001 shown in FIG. 13A shows the data structure of the version V1.00. A table schema 1002 shown in FIG. 13B shows the data structure of the version V2.00. Each of the FW of the version V1.00 and the FW of the version V2.00 has setting value data of a different schema. In the version V2.00, compared to the version V1.00, information of MetaInfo is increased and it is changed such that the table is divided into a plurality of sections and managed.

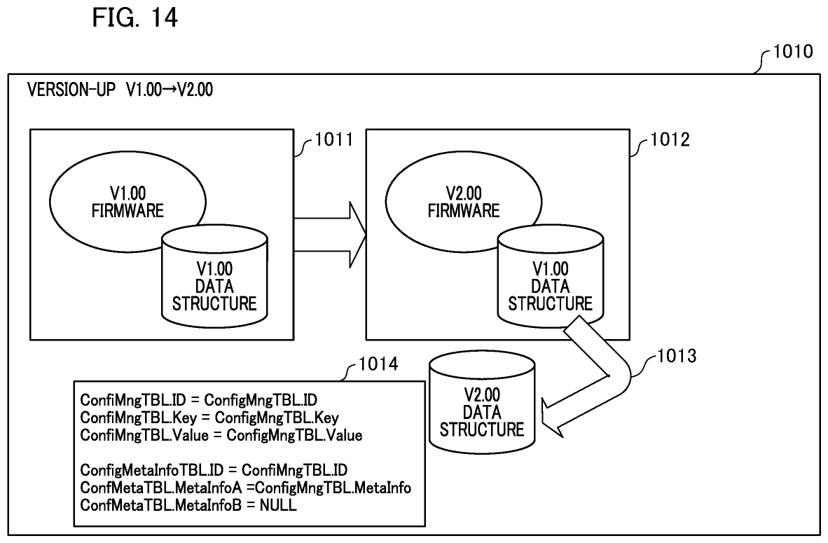

FIG. 14 is an explanatory view of version-up of FW. A schematic view 1010 of the FW and the data is a schematic view of the FW and the data when version-up of the FW is performed from the version V1.00 to the version V2.00. An image 1011 before updating shows a situation in which the FW of the version V1.00 before FW updating starts while retaining the data structure of V1.00. An image 1012 immediately after updating shows a situation in which the FW of the version V2.00 immediately after FW updating starts while retaining the data structure of V1.00. In this manner, if the FW is updated from the version V1.00 to the version V2.00, the updated FW has been updated to the version V2.00 immediately after updating, but the data structure is in a state of inheriting the data structure of the version V1.00. Further, the FW version V2.00 generally has logic 1014 for conversion to a new data structure in order to recognize the old data structure (data structure of the version V1.00) and execute migration 1013. The device 102 can be started without any particular problem by executing data migration after version-up of the FW and converting the data structure of the version V1.00 into the data structure of the version V2.00. In this manner, during version-up, data migration is executed so that the data structure before updating can be utilized by being converted by the updated FW.

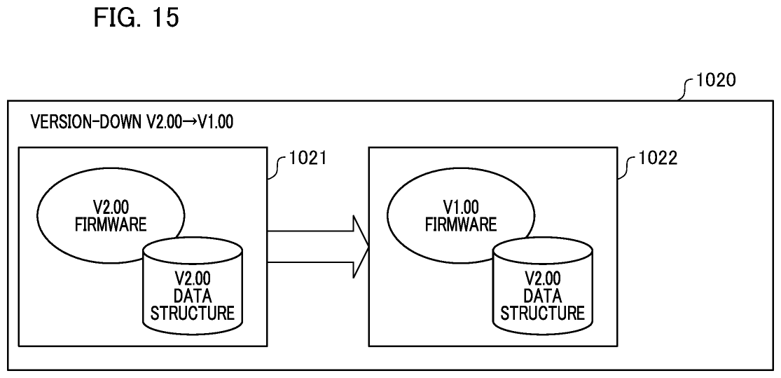

FIG. 15 is an explanatory view of version-down of FW. A schematic view 1020 of the FW and the data is a schematic view of the FW and the data when version-down of the FW is performed from the version V2.00 to the version V1.00. An image 1021 before updating shows a situation in which the FW of the version V2.00 before FW updating starts while retaining the data structure of V2.00. An image 1022 after updating shows a situation in which the FW of the version V1.00 after updating of the FW starts while retaining the data structure of V2.00. In this manner, if the FW is updated from the version V2.00 to the version V1.00, the updated FW has been updated to the version V1.00 immediately after updating, but the data structure is in a state of inheriting the data structure of the version V2.00. The FW of the version V1.00 cannot understand the data structure of the version V2.00 and cannot execute data migration either. For this reason, during version-down, the FW cannot be started and shifted to a state in which a user is prompted to clear the data. If starting is performed again by performing the clear processing, the FW of the version V1.00 restructures data having a structure of V1.00 from zero such that the device 102 can be started. In this manner, when the processing of updating the FW is version-down, starting cannot be performed and a case of interaction waiting for clearing occurs. In order to avoid a startup failure due to such version-down, in the present example, the task control unit 404 makes a reservation for automatic execution of clearing in advance in S903 and the clear processing is performed in S908. Accordingly, data can be automatically cleared without user interaction and the device 102 can be started without a startup failure. However, since the connection relationship between the device 102 and the device management system is also cancelled by the clear processing, during updating of the FW accompanying version-down, a registration code is prepared in advance and is acquired by the device 102. In addition, as necessary, a connection application which is an extended application operating in the updated FW is prepared in advance and is acquired by the device 102. When version-down is performed, the connection relationship can be restored by utilizing the registration code and the connection application which have been acquired before the processing of updating the FW.

As described above, according to the present example, even when version-down of the FW is performed and various kinds of settings are cleared so that connection between the device 102 and the device management service 109 is cancelled, the device 102 can restore the connection.

### Example 2

In Example 1, an example in which the device 102 can restore the connection to the device management service 109 even when version-down of the FW is performed and various kinds of settings are cleared has been described. However, since various kinds of cleared settings are not restored, there is a need for a user to manually restore the settings. In the present example, an example in which the device 102 can restore various kinds of settings which have been cleared due to version-down of the FW will be described. Hereinafter, only points different from Example 1 will be described.

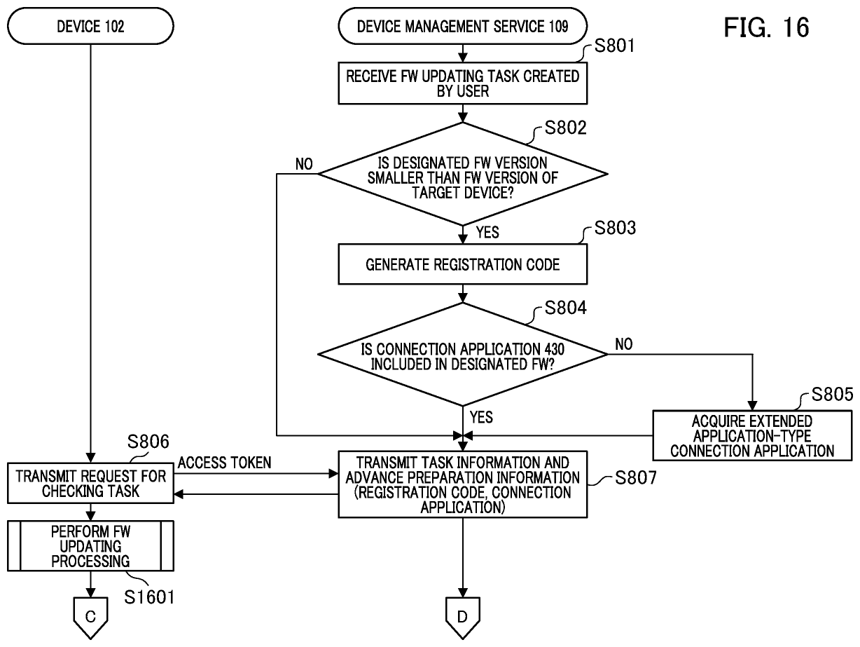

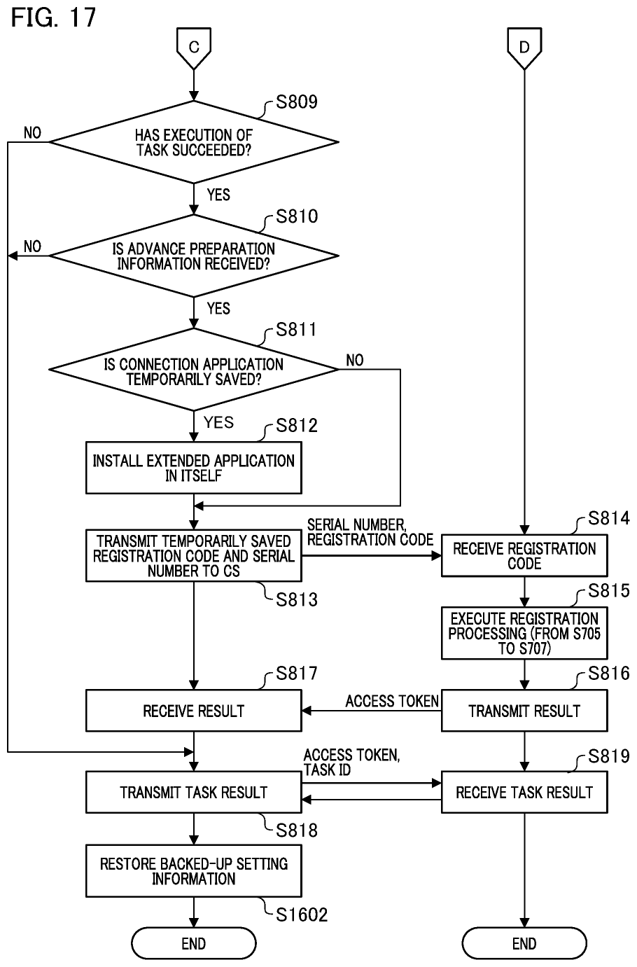

FW updating task execution processing in Example 2 will be described using FIGS. 16 and 17. The FW updating task execution processing in the present example is processing of executing a task of updating the FW of the device. FIGS. 16 and 17 are flowcharts showing the FW updating task execution processing. Each step of processing executed by the device in the FW updating task execution processing is realized by the CPU 251 executing a program stored in the memory (the ROM 252 or the HDD 255). Each step of processing executed by the device management system in the FW updating task execution processing is realized by the CPU 201 of the device management service 109 executing a program stored in the memory (the ROM 202 or the HDD 207).

Hereinafter, a case of updating the FW of the device 102 will be described as an example. The same reference signs are applied to processing similar to the FW updating task execution processing (FIGS. 10 and 11) of Example 1, and description thereof will be omitted. The FW updating task execution processing is started by a user designating an updating target device and FW to be applied and pressing the OK button 644 in the task creation screen 640 provided by the device management system. The processing from S801 to S807 is similar to the processing described in Example 1. Regarding a response to the task checking request, the device 102 which has received the task information and the advance preparation information from the device management service 109 executes the FW updating processing of S1601.

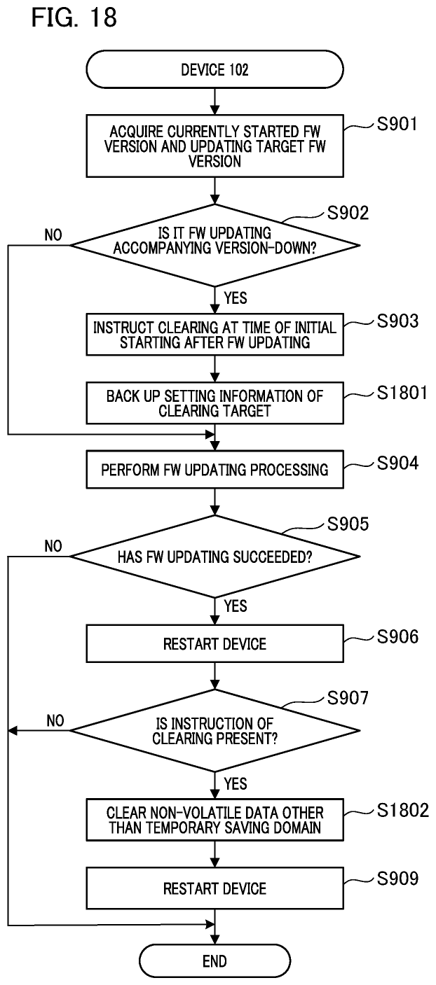

Details of the FW updating processing in S1601 will be described using FIG. 18. FIG. 18 is a flowchart showing FW updating processing in Example 2. Each step of processing executed by the device in the FW updating processing is realized by the CPU 251 executing a program stored in the memory (the ROM 252 or the HDD 255). Hereinafter, a case in which the device 102 executes the FW updating processing will be described as an example. The same reference signs are applied to processing similar to the FW updating processing (FIG. 12) of Example 1, and description thereof will be omitted.

S901 to S903 are similar to those of the processing described in Example 1. When occurred updating of the FW is version-down, an instruction of clearing is performed in S903, and then the device 102 performs the processing of S1801. In S1801, the task control unit 404 instructs backup of setting information of a clearing target to the data clearing supervisory unit 415. Specifically, the data clearing supervisory unit 415 which has received an instruction of backup performs backup of the license data 422, the setting value data 423, and the application management data 424. In addition, the data clearing supervisory unit 415 also performs backup of data of the system application, such as the copy application data 451 and the send application data 461. When an extended application is installed, the data clearing supervisory unit 415 also backs up the extended application retained in the application management data 424. The data clearing supervisory unit 415 also performs backup of the system data 421. However, there is no need to back up the task information and the advance preparation information saved in the temporary saving domain.

For example, the backed-up data is converted into a file in an extensible markup language (XML) form. The form of the backed-up data is not limited to the XML form, and a different form may be adopted. When the backup data is constituted of a plurality of files, it may be archived in one file in a zipped form or the like. For example, the backup data converted into a file is retained in the temporary saving domain of the system data 421 of the device 102. When the backup data is retained in the temporary saving domain of the system data 421 of the device 102, it is desirable to save it in association with the task information and the advance preparation information which have been temporarily saved in advance.

In addition, the backup data may be temporarily saved in the DB 308 of the device management service 109. When the backup data is temporarily saved in the device management service 109, the task control unit 404 sends the backup data to the device management service 109 via the network communication unit 403 together with the serial number of itself. If the backup data is received from the device 102 via the communication unit 305, the function control unit 302 of the device management service 109 temporarily saves the received backup data in the DB 308 in association with the serial number.

The backup data is data before version-down of the FW is performed. For this reason, if the backup data is restored as it stands in the step which will be described below, there is a probability that the FW will be in a starting inconsistent state, which may cause a startup failure of the device 102. For this reason, it is desirable that the data clearing supervisory unit 415 also perform backing up together with the data structure (schema) of each setting value.

If backup processing is completed in S1801, the processing of S904 is executed. Since the processing of S904 to S907 is processing similar to that of Example 1, description thereof will be omitted. When it is judged in S907 that an instruction of clearing is present, the data clearing supervisory unit 415 performs the processing of S1802. In S1802, the data clearing supervisory unit 415 performs the clear processing. In the clear processing, the data clearing supervisory unit 415 clears non-volatile data other than the data saved in the temporary saving domain. In the clear processing of Example 1, the data clearing supervisory unit 415 maintains the task information and the advance preparation information saved in the temporary saving domain without deletion. In the clear processing of Example 2, in addition to the task information and the advance preparation information saved in the temporary saving domain, the data clearing supervisory unit 415 also maintains the backup data generated in S1801 without deletion. Specifically, the data clearing supervisory unit 415 first performs initialization of the license data 422, the setting value data 423, and the application management data 424. Moreover, the data clearing supervisory unit 415 also performs initialization of data of the system applications, such as the copy application data 451 and the send application data 461. The data clearing supervisory unit 415 also performs initialization of the system data 421 but the task information, the advance preparation information, and the backup data saved in the temporary saving domain are maintained without being erased. If the clear processing of S1802 is completed, the device 102 is restarted in S909. Since the processing of S909 is similar to the processing described in Example 1, description thereof will be omitted.

Description returns to the FW updating task execution processing (FIGS. 16 and 17). If the FW updating processing of S1601 is completed in the device 102, the processing of S809 is executed. Since S809 to S819 are similar to those in the processing described in Example 1, description thereof will be omitted. In S818 and S819, if processing of transmitting and receiving the task result is completed, the processing of S1602 is performed in the device 102. In S1602, the task control unit 404 of the device 102 restores the backup data which has been backed up in S1801. Specifically, the task control unit 404 acquires the backup data of itself from the temporary saving domain of the system data 421 or the device management service 109 and calls the data clearing supervisory unit 415. The data clearing supervisory unit 415 analyzes the acquired backup data, identifies restoration destinations, and restores them in the license data 422, the setting value data 423, and the application management data 424, respectively. Similarly, restoration of data of system applications, such as the copy application data 451 and the send application data 461 is also performed. Moreover, when an extended application is included in the backup data, the extended application is delivered to the application management unit 414, and the extended application is installed. The entity of the installed extended application is retained in the application management data 424. When each step of restoration processing is performed, the data clearing supervisory unit 415 compares the data structure before FW updating included in the backup data and the current data structure (after updating of the FW). If the data structures of the pieces of data coincide with each other, it is possible to judge that the backup data before FW updating has compatibility with the data of the updated FW. Therefore, even if the data is restored as it stands, a startup failure of the device 102 will occur. Meanwhile, when the data structures before and after FW updating differ, the data clearing supervisory unit 415 discards the backup data without restoring it.

As described above, according to the present example, even when version-down of the FW is performed, the device 102 not only can restore connection with the device management service 109 but also can maintain the setting value before FW updating.

### Example 3

In Examples 1 and 2, examples in which the device management service 109 generates a registration code in a stage in which it is determined that version-down of the FW of the target device is performed in the FW updating task execution processing have been described. In Example 3, an example in which a registration code for restoring the connection relationship is generated during the device registration processing that is a timing different from those in Examples 1 and 2 will be described. Hereinafter, only points different from Example 1 will be described.

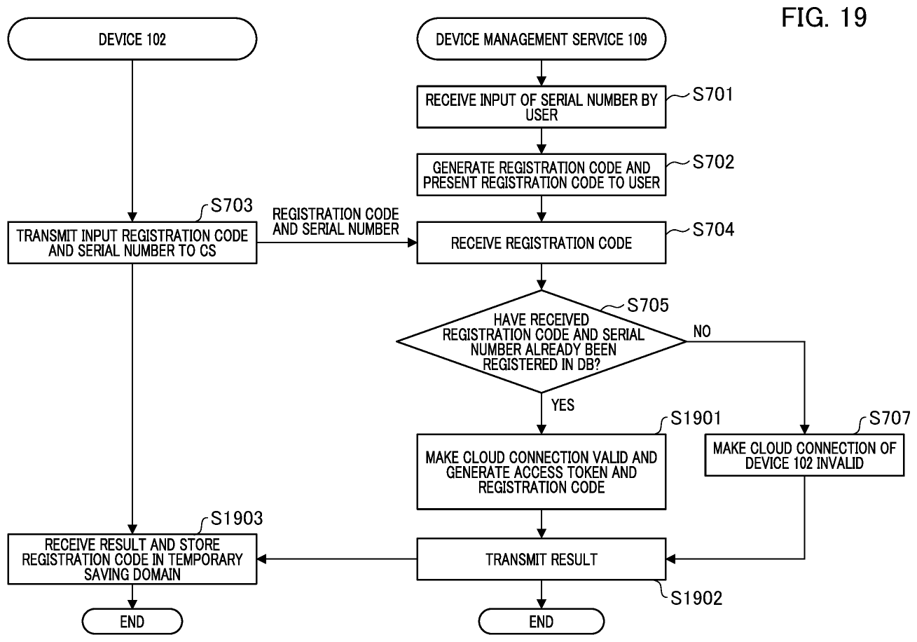

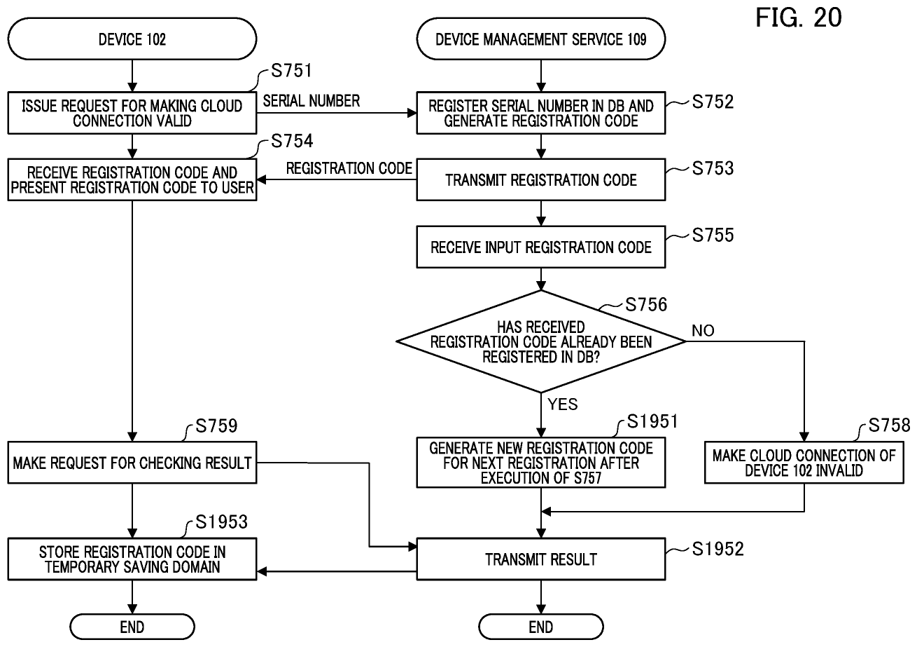

The device registration processing in Example 3 will be described using FIGS. 19 and 20. The device registration processing is processing of registering the management target device in the device management system. Each step of processing executed by the device in the device registration processing is realized by the CPU 251 executing a program stored in the memory (the ROM 252 or the HDD 255). Each step of processing executed by the device management system in the device registration processing is realized by the CPU 201 of the device management service 109 executing a program stored in the memory (the ROM 202 or the HDD 207).

First, using FIG. 19, a case in which a user starts the processing of registering a device in the screen provided by the UI control unit 301 of the device management service 109 in the information processing device (not shown) and the like will be described. FIG. 19 is a flowchart showing an example of device registration processing in Example 3. In FIG. 19, the same reference signs are applied to steps of processing similar to those of FIG. 8, and description thereof will be omitted. Since the processing of S701 to S705 and S707 is similar to the processing described in Example 1, description thereof will be omitted. In S705, the function control unit 302 of the device management service 109 judges whether or not the serial number and the registration code received from the device 102 have already been registered in the device management table 620. When it is judged that the serial number and the registration code received from the device 102 have already been registered in the device management table 620, the processing of S1901 is performed.

In S1901, the function control unit 302 of the device management service 109 makes cloud connection of the device 102 valid and generates an access token. Moreover, it generates a registration code for next registration. That is, in S1901, in addition to the processing of S706 in Example 1, a registration code to be used when the device 102 is registered in the device management service 109 next time is generated and stored in the registration code 623 of the device management table 620. If the processing of S1901 is completed, the device management service 109 performs the processing of S1902.

In S1902, the function control unit 302 of the device management service 109 transmits the result of the device registration processing to the device 102 via the communication unit 305. When an access token and a registration code are generated in S1901, the function control unit 302 also transmits the access token and the registration code together with the result of the device registration processing to the device 102. That is, in Example 1, the access token is transmitted together with the result when the result which has succeeded in registering the device is transmitted to the device 102. However, in the present example, the registration code is also transmitted together with the result in addition to the access token.

In S1903, the connection management unit 431 of the connection application 430 of the device 102 receives the result of the device registration processing from the device management service 109 via the network communication unit 403. When cloud connection is made valid, the fact that cloud connection is made valid is stored in the cloud connection application data 440. In addition, when the access token is received, the received access token is stored in the access token management unit 432. The access token is used at the time of access to the device management system thereafter. Moreover, in the present example, when the registration code is received, the task control unit 404 saves the received registration code in the temporary saving domain of the system data 421. In this manner, in the present example, when the device 102 is registered in the device management system, a new registration code which can be utilized for registering a device next time is generated and is saved in both the device management service 109 and the device 102.

Next, using FIG. 20, a case in which a user starts the processing of registering a device by operating the device to be registered will be described. FIG. 20 is a flowchart showing an example of the device registration processing in Example 3. In FIG. 20, the same reference signs are applied to processing similar to that of FIG. 9, and description thereof will be omitted. Since the processing of S751 to S756, S758, and S759 is similar to the processing described in Example 1, description thereof will be omitted.

In S705, when it is judged that the registration code received from the device 102 by the device management service 109 has already been registered in a device management table 920, the processing of S1951 is performed. In S1951, the function control unit 302 of the device management service 109 stores the affiliated tenant of the user in the affiliated tenant 622 of the device management table 620. Moreover, the function control unit 302 of the device management service 109 makes cloud connection of the device 102 valid and generates an access token. The processing of making cloud connection of the device 102 valid and generating an access token is similar to the processing of S706. Moreover, in the present example, the function control unit 302 generates a registration code to be used when the device 102 is registered in the device management service 109 next time and stores it in the registration code 623 of the device management table 620. That is, in S1951, in addition to the processing of S757 in Example 1, processing of generating and saving a registration code which can be utilized next time.

After a certain period of time has elapsed from execution of S754, the device 102 executes the processing of S759. In S759, the connection management unit 431 of the device 102 transmits a result checking request for checking the result of the device registration processing to the device management service 109. The device management service 109 which has received a result checking request from the device 102 performs the processing of S1952. In S1952, the function control unit 302 of the device management service 109 responds to the device 102 with the result of the device registration processing. In S1952, in addition to contents transmitted to the device 102 in S760 of Example 1, the registration code generated in S1951 is also transmitted. Specifically, first, the function control unit 302 checks whether or not cloud connection of the device 102 corresponding to the serial number has become valid on the basis of the serial number included in the received result checking request. The function control unit 302 checks whether or not the received serial number is stored in the serial number 621 of each record of the device management table 620, and when it is stored therein, the function control unit 302 checks whether or not the value of the validity state 624 is “ON”. When the value of the validity state 624 is “ON”, the function control unit 302 acquires the value of the access token 625 and the value of the registration code 623 and transmits them to the device 102 together with the result indicating the fact that registration processing has succeeded. When the received serial number is not present, or when the value of the validity state 624 is a value other than “ON”, the function control unit 302 transmits the fact that cloud connection is invalid to the device 102.

When an access token or a registration code is included in the response to the result checking request, the device 102 performs the processing of S1953. In S1853, the task control unit 404 of the device 102 stores the access token received from the device management service 109 in the access token management unit 432 and stores the registration code in the temporary saving domain of the system data 421.

As described above, according to the present example, the registration code used during registration in the device management service 109 next time can be saved in the device 102 during the device registration processing. Thereafter, when there is a need to restore the connection relationship between the device and the device management system, the connection relationship can be restored using the registration code which has already been saved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-028837, filed Feb. 27 2023, which is hereby incorporated by reference wherein in its entirety.

What is claimed is:

1. An image processing device comprising:
a memory storing instructions; and
a processor executing the instructions causing the image processing device to:
acquire a code for restoring a connection relationship with a device management system for providing a service from the device management system when information of the image processing device has already been registered in the device management system so as to be provided with a service;
manage the code; and
restore the connection relationship with the device management system using the code when updating of software of the image processing device, which is required to restore the connection relationship for providing a service with the device management system, has occurred.

2. The image processing device according to claim 1,
wherein the processor restores the connection relationship with the device management system using an extended application executed by the updated image processing device, and the code.

3. The image processing device according to claim 1,
wherein updating of the software is version-down of predetermined firmware.

4. The image processing device according to claim 3,
wherein the process further executes an instruction causing the image processing device to clear system data of the image processing device after updating of the software that is version-down of the predetermined firmware, and
wherein the processor does not clear the code.

5. A system including a device management system providing a service to an image processing device, and an image processing device,
wherein the device management system comprises:
a memory storing instructions; and
a processor executing the instructions causing the device management system to:
generate a code for restoring a connection relationship with the device management system for providing a service when information of the image processing device has already been registered in the device management system;
manage the code;
transmit the code to the image processing device; and
restore communication between the device management system and the image processing device when the code received from the image processing device has already been registered in the device management system, and
wherein the image processing device comprises:
a memory storing instructions; and
a processor executing the instructions causing the image processing device to:
acquire the code from the device management system;
manage the code; and
restore the connection relationship with the device management system by transmitting the code to the device management system when updating of software of the image processing device, which is required to restore the connection relationship for providing a service with the device management system, has occurred.

6. The system according to claim 5,
wherein the device management system generates the code and transmits the code to the image processing device when updating of software of the image processing device, which is required to restore the connection relationship for providing a service with the device management system, is instructed.

7. The system according to claim 5,
wherein the device management system transmits an extended application, which is capable of being installed in software applied to the image processing device to the image processing device together with the code when an extended application for performing connection to the device management system is not included in software applied to the image processing device due to updating of the software.

8. The system according to claim 5,
wherein the device management system generates the code and transmits the code to the image processing device when information of the image processing device is registered in the device management system and the connection relationship with the image processing device for providing a service becomes valid.

9. A method for controlling an image processing device, the method comprising:
acquiring a code for restoring a connection relationship with a device management system for providing a service from the device management system when information of the image processing device has already been registered in the device management system so as to be provided with a service;
managing the code; and
restoring the connection relationship with the device management system using the code when updating of software of the image processing device, which is required to restore the connection relationship for providing a service with the device management system, has occurred.
